(19) United States
(12) Patent Application Publication
(10) Pub. No.: US 2025/0387913 A1
(43) Pub. Date: Dec. 25, 2025

(54) Method for Determining an Operation to be Performed by a Robot, Method for Determining and Checking an Operation to be Performed by a System, Device for Data Processing, Computer Program, and Computer-Readable Medium

(71) Applicant: Bayerische Motoren Werke Aktiengesellschaft, Muenchen (DE)

(72) Inventors: Johannes KLEPSCH, Muenchen (DE); Andre LUCKOW, Pullach i. Isartal (DE); Philipp ROSS, Muenchen (DE); Yannick VAN DIJK, Muenchen (DE)

(21) Appl. No.: 18/880,324

(22) PCT Filed: Sep. 4, 2023
(86) PCT No.: PCT/EP2023/074160

§ 371 Date: Dec. 31, 2024

(30) Foreign Application Priority Data
Sep. 20, 2022 (DE) 10 2022 124 067.3

(51) Int. Cl. B25J 9/16; G06F 17/11

(52) U.S. Cl. CPC B25J 9/1671; G06F 17/11

(57) ABSTRACT

A method for determining at least one operation to be performed by at least one robot for machining at least one component is provided. An electronic computing device determines product data which characterizes the at least one component. The electronic computing device determines system data which characterizes a system including the robot for performing the at least one operation. The electronic computing device generates a simulation model that simulates the system and the at least one component based on the product data and the system data. The electronic computing device performs a simulation by way of the simulation model, as a result of which the electronic computing device determines process data describing multiple step groups, each of the step groups comprising multiple sub-steps of the at least one operation which differ from one another.

### BACKGROUND AND SUMMARY

The invention relates to a method for determining an operation to be performed by a robot for processing at least one component. The invention also relates to a method for determining and checking an operation to be performed by a system for processing a component. The invention also relates to a device for data processing, a computer program and a computer-readable medium.

DE 10 2012 218 297 B4 discloses a method for optimizing a control system of a machine. A robot is known from U.S. Pat. No. 8,886,359 B2. JP 6457473 B2 discloses a machine learning device, a robotic system and a machine learning method. An offline robot programming device is known from JP 2013-99815 A. In addition, a method for programming an industrial robot is known from DE 10 2014 216 514 B3. Furthermore, an optimization method is known from EP 3 685 968 A1.

The object of the present invention is to create a method, a device, a computer program and a computer-readable medium so that products can be manufactured in a time-efficient and cost-effective manner.

This object is achieved by the features of the claimed invention.

A first aspect of the invention relates to a method for determining at least one operation to be performed by a robot to process at least one component. For example, the operation is an operation for the production of a product, which is made from the component, for example, by processing the component. The determination of the operation can be understood in particular as the determination of a computer program, also simply referred to as a program, according to which the robot can be operated in such a way that the robot performs the operation and thereby processes the component, in particular the product. In other words, the operation may be described or characterized as a computer program, also known simply as a program, wherein the computer program includes commands which cause the robot to perform the operation, in particular when the computer program is executed by a computer, wherein the computer controls the robot by executing the computer program, for example. Furthermore, the computer can be a component of the robot.

In a first step of the method, product data are determined by way of an electronic computing device, which can include, for example, the aforementioned computer and/or another, additional computer, which product data characterize or describe the at least one component to be processed by the robot during the at least one operation. For example, the product data are determined in such a way that the electronic computing device retrieves the product data from an in particular electronic data storage device, This can be done automatically or depending on at least one input into the electronic computing device, in particular made by a person. In particular, the method is carried out by way of the electronic computing device, which is preferably a computer other than the computer running the aforementioned robot program.

In a second step of the method, the electronic computing device is used to determine system data that characterize a system that includes at least the robot and that is also referred to as a manufacturing system for performing the at least one operation. The system data can be determined, for example, in such a way that the electronic computing device retrieves the system data from the mentioned data memory and/or from another, further data memory. This can be done automatically or depending on at least one input into the electronic computing device made by the person.

In a third step of the method, process data that characterize the at least one operation are determined by way of the electronic computing device. The process data can be determined, for example, in such a way that the electronic computing device retrieves the process data from the mentioned data storage device and/or from the other data storage and/or from another, third data storage device. This can be done automatically or depending on at least one input into the electronic computing device made by the person.

In a fourth step of the method, a simulation model is generated, i.e. calculated, by way of the electronic computing device on the basis of the product data and the system data and the process data, wherein the simulation model at least simulates the system and the component. It can be seen that the product data, the system data and the process data are input data for or into the simulation.

In a fifth step of the method, a simulation is carried out by way of the electronic computing device by way of the simulation model, wherein simulation data that describe or characterize multiple step groups are determined, in particular calculated, by way of the electronic computing device, wherein the respective step group contains multiple different sub-steps of the operation. It can be seen that the simulation data are output data or a result of the simulation. In particular, the simulation data characterize or describe at least one respective property of the respective sub-step. The respective property of the respective sub-step can be, for example, a period of time, also referred to as a time span, that is necessary for the system, in particular the robot, to carry out or perform the respective sub-step. In other words, the respective time span is a respective time of the respective sub-step, wherein the system, in particular the robot, needs the respective time to execute the respective sub-step belonging to the respective time. The operation can be created by selecting exactly one of the respective sub-steps of the respective step group from the respective step group, also known as a group, and stringing together the selected sub-steps. If the system, in particular the robot, successively carries out the sequenced sub-steps, then the robot performs the operation, since the strung together sub-steps, in particular in total, make up the operation.

In a sixth step of the method, a target function of an optimization problem is created or generated by way of the electronic computing device, wherein the target function contains the sub-steps of the step groups as parameters. For example, the target function is or describes a sum of all time spans of the sub-steps or the combinations of the sub-steps, wherein this function, i.e. the target function, is to be minimized in order to optimize the operation with regard to the cycle time thereof, for example, and thus to determine a sub-step or the combination of the sub-steps from the step group, which leads to the operation being able to be carried out as briefly or quickly as possible. In other words, the simulation determines the options or the combination of the sub-steps from the step groups in order to perform the operation by way of the system taking into account the product data. From these options, especially by minimizing the partial function, the variant, i.e. the combination or the option, which takes the least time is chosen, for example, i.e. which results in the shortest time required for the operation, i.e. for its execution. The respective combination or option includes, for example, from the respective step group, in particular from all step groups, exactly one of the respective sub-steps of the respective step group.

In a seventh step of the method, the target function is minimized by way of the electronic computing device, whereby one, in particular exactly one, of the respective sub-steps of the respective step group is selected from the respective step group and the selected sub-steps are strung together, whereby the operation is formed, i.e. determined, in particular calculated. The background to the invention is in particular that the operation can be performed in different ways, i.e. created and performed, wherein the ways differ from each other in particular in that the operation can be composed of the different sub-steps. For example, each sub-step can be carried out on its own by the system, in particular by the robot, for which the system needs the respective specified period of time. The respective sub-steps of the respective step group differ from each other, for example, in that the respective sub-steps of the respective step group can be carried out in different ways, in particular in order to achieve the same result of the respective sub-step. An example of this is that a first robot arm of the robot, also known as the first robot axis, can be rotated about a rotation axis relative to a second robot arm of the robot, also known as the second robot axis, starting from an initial position, by 270 degrees in a first direction of rotation around the axis of rotation or by 90 degrees in a second direction of rotation around the axis of rotation and opposite to the first direction of rotation. For example, the rotation of the first robot arm by 270 degrees in the first direction of rotation is a first of the sub-steps of a first of the step groups, wherein, for example, the rotation of the first robot arm by 90 degrees in the second direction of rotation is a second of the sub-steps of the first step group. For example, the first sub-step and the second sub-step lead to the same result, which can be in particular a position of a tool of the robot, in particular of a point of the tool of the robot. It can be seen that depending on the number of sub-steps of the respective step group and depending on the number of step groups, there may be a large number of possible combinations in which the respective sub-steps can be combined with each other, i.e. strung together to form the operation.

The optimization problem and thus the target function describe an optimization task that is in the form of a minimization task, for example, and that is to be achieved, which is achieved by minimizing the target function. In particular, for example, the target function may be formed or shaped in such a way that by minimizing the target function the operation is formed from the sub-steps of the target groups in such a way that the operation is carried out as quickly as possible, i.e. that the time required by the system to perform the operation is as short as possible. However, the minimization of the target function and thus of the optimization problem does not necessarily have to consist in selecting the shortest sub-step of the respective step group and thus in stringing together the respective shortest sub-steps, it is conceivable that if the operation can no longer be performed as a whole, if, for example, carrying out the shortest sub-step of one of the step groups does not allow the shortest sub-step of another of the step groups to be carried out. Thus, the minimization of the target function results in the operation that can be performed and, for example, which is the shortest in relation to all possible operations that can be assembled from the sub-steps and performed. Embodiments of the invention thus make it possible to determine the operation according to the target function in a time-efficient and cost-effective manner and as a result, for example, to determine, in particular to calculate, the aforementioned computer program, also referred to as a robot, in a time-efficient and cost-effective manner. For example, the operation is or describes at least one path along which at least part of the robot is to be moved or is moved when the operation is performed. Thus, the method is a way to implement path planning, also known as robot path planning, for determining the operation and thus for determining the path in a particularly time-efficient and cost-effective manner and, in particular, in an at least partially automated, in particular fully automated manner.

After successful robot path planning, i.e. after determining the operation, which can be determined and thus planned in a particularly time-efficient and cost-effective manner, the operation can actually be performed by way of the system and thus by way of the robot in order to process the component and thus produce the aforementioned product, for example. Thus, embodiments of the invention enable time-efficient and cost-effective production of the product or products, in particular in the context of series production.

In order to be able to process the component in a particularly time-efficient and cost-effective manner and thus, for example, to be able to manufacture the product in a particularly time-efficient and cost-effective manner, it is envisaged in the further development of the invention that the robot is controlled by way of the electronic computing device or by way of another, further electronic computing device and thus operated, in particular controlled, in such a way that the robot performs the determined operation.

Another embodiment is characterized in that the product data characterize an in particular external geometry of the component and/or an interference geometry that the robot must avoid. The interference geometry is a place or places to which the robot or the system should not or cannot be moved, so that undesirable collisions can be avoided. By taking into account the geometry of the component and/or the interference geometry, the operation can be determined in a particularly time-effective and cost-effective manner.

In another, particularly advantageous embodiment of the invention, it is envisaged that the system data characterize robot arms of the robot, also referred to as robot axes, connected in an articulated manner and in the form of an industrial robot, for example. The robot arms connected in an articulated manner, which can be moved relative to each other, for example by rotation and/or translation, enable operating in different ways, so that by taking the robot arms into account, a large solution space can be created, within which the operation can be determined particularly advantageously with regard to the target function.

Another embodiment is characterized in that the system data characterize at least one tool of the robot that can be moved by way of the robot relative to the component and in particular in space and that is intended for carrying out the operation. By taking the tool into account, the operation can be determined particularly precisely and so as to be executable.

For example, the operation involves using the robot to apply at least one seam to the component, for example as a plastic seam and, for example, as a sealing and/or adhesive seam. The seam can be a PVC seam (PVC—polyvinyl chloride). Alternatively or additionally, the operation can include that at least one weld is carried out by way of the robot. The weld can be a spot weld, or a seam weld is produced by the welding. The welding, for example, connects the component to at least one other component. The tool can therefore be, for example, an application tool to apply the aforementioned seam, i.e. a material forming the seam, such as a sealant and/or an adhesive, to the component. Further, the tool can be a welding tool for performing the welding. The respective sub-step is also referred to as the respective application.

Finally, it has been shown to be particularly advantageous if the process data describe or characterize at least one trajectory along which at least part of the robot is to be moved and/or at least a speed at which at least part of the robot can be moved, in particular along the trajectory. For example, the trajectory can be the path mentioned earlier or part of the path. The background to this embodiment is that there can be multiple trajectories along which at least part of the robot can be moved in order to carry out the respective sub-step and thus the operation. The shortest trajectory does not necessarily have to be the one that causes the operation to take as short a time as possible. Embodiments of the invention make it possible to string together the sub-steps and thus the trajectories in such a way that the operation can be carried out by the system, wherein the minimization of the target function results in the determined operation being, for example, the shortest of the operations that can in principle be carried out by the system. This means that the component can be processed in a particularly time-efficient and cost-effective manner, so that the product can be manufactured in a particularly time-effective and cost-effective manner.

A second aspect of the invention relates to a method for determining and checking at least one operation to be performed by a system for processing at least one component. In particular, the system contains at least one robot, for example. With the method of the second aspect of the invention, design data characterizing multiple distinct products are stored in at least one data memory. The data memory also stores system data that characterize multiple different systems for carrying out manufacturing steps. By way of an electronic computing device, a first subset of the design data is selected from the design data depending on inputs into the electronic computing device made by a person, for example, wherein the first subset characterizes in particular exactly one of the products. In particular, the following and previous explanations of the product data can be applied to the design data and vice versa. In addition, depending on the inputs, a second subset of the system data are selected from the system data, wherein the second subset characterizes in particular exactly one of the systems. In the second aspect of the invention, depending on the first subset, at least one operation required for the production of the product characterized by the first subset is automatically calculated and thereby determined by way of the electronic computing device. This is to be understood in particular as meaning that the operation is calculated by way of the electronic computing device, in particular exclusively, on the basis of the selected design data, i.e. on the basis of the design data of the selected, first subset, so that automation is provided at least with regard to the determination of the operation. In addition, in the second aspect of the invention, the electronic computing device is used to check, depending on the second subset, whether the system characterized by the second subset is capable, i.e., designed, to perform the calculated operation. For example, the electronic computing device performs a simulation based on the first subset and the second subset. In particular, the simulation is carried out by way of a simulation model that simulates the system characterized by the second subset and the product characterized by the first subset. In the simulation, the electronic computing device simulates whether or that the operation is performed by the system. If the simulation finds that the system can perform the entire determined operation, it is recognized that the system is able to perform the operation. However, if the simulation determines that the system cannot carry out at least part of the determined operation or the entire operation, it is determined that the system is not able to perform the determined operation. This means that the operation can be determined and checked in a particularly time-effective and cost-effective manner.

In particular, the invention is based on the following findings and considerations: Robots are used to manufacture products in order to be able to manufacture the products in a time-efficient and cost-effective manner. In particular, robots are used in the automotive industry to manufacture vehicles in order to produce the vehicles at least partially in an automated manner and thus time-efficiently and cost-effectively. Operations such as gluing, welding and painting are usually carried out at least largely in an automated manner by robots such as industrial robots. Before a robot is able to perform such an operation, also known as a task, the robot or an electronic computing device for operating the robot is programmed. Usually, the robot is taught to perform the operation step by step. This programming can be carried out directly in the system containing the robot and thus online, or in a virtual environment and thus offline. The advantage of offline programming is that production does not have to be interrupted or is only slightly interrupted in order to make changes relating to the operation. Robot manufacturers often offer their own software product to carry out offline programming. There are also software solutions that can be used to carry out offline programming across manufacturers.

Examples of such software products from robot manufacturers include RobotStudio, Roboguide and KUKA.Sim. Cross-manufacturer software solutions include RoboDK, OCTOPUZ and Process Simulate, for example. Usually, the first step for any software is that a virtual environment of a robot cell containing the robot must be set up manually and thus by a person. This process is time-consuming and prone to operator errors. As a rule, the data of the virtual environment to be built can be divided into three categories:
1. System data (robots, conveyor technology, material supply, etc.)
2. Product data (geometric representation of the component or product)
3. Process data (list of robot tasks by product including process parameters)

Usually, when these data are changed, a manual enablement or addendum must be carried out in the software. This in turn leads to an increased amount of time and stands in the way of short development cycles. Such disadvantages can be avoided by embodiments of the invention. Conventional software solutions make it possible to transfer tasks from one robot to another robot, or to change the order of a task sequence. However, usually any such changes must be made manually and thus by a person. The robot program usually has to be reworked afterwards in order to make the movements of the robot between tasks practicable and collision-free. As a result, a lot of effort and time has to be invested in order to design a robot program optimally in terms of cycle time.

In particular, two disadvantages of conventional solutions were identified. A first of the disadvantages is that there is no consistency between input data and the robot program. A second of the disadvantages is that there is no possibility for automated optimization of robot programs. These problems lead to the following disadvantages:
increased costs due to the effort of manual programming;
long development time of the product, as the hardware can only be secured after the manual programming has been completed;
untapped potential in terms of the efficiency of a system, since due to manual programming, only a subset of the solution space in the production process can be examined, and thus the global optimum is not guaranteed to be identified; and
due to the untapped potential, the theoretically possible production volume is underachieved.

Embodiments of the invention enable a time-efficient and cost-effective cycle time optimization by optimizing the operation or the robot program, in particular by way of automated data provision, in order to avoid the aforementioned disadvantages.

For example, a digital image of the system, which is also known as a robot system and which includes the robot, is created, in particular including all interference contours. This digital image is created, for example, as a computational model, a model or a simulation model, wherein the digital image is created, for example, on the basis of the system data and the product data. In particular, this is followed by an interpretation of robot tasks, i.e. at least one task to be carried out or to be performed by the robot. The task is, for example, the aforementioned operation, which may include gluing and/or welding. Alternatively or additionally, the operation may include the application of an adhesive and/or a sealing material, for example in the form of a plastic, in particular PVC, to the component. In particular, this is followed by an optimization, for example, in the course of which the operation is determined and, in particular, optimized, in particular by minimizing the target function as described. Subsequently, for example, the optimized operation, i.e. the determined operation (robot program), is output.

A further step can include a validation of the optimized robot program (operation), in particular with regard to collisions and practicability with reduced speed of the robot. A further step can include the use of the determined and thus optimized operation (robot program) in a production process, in which, for example, the robot is operated according to the determined operation and thus processes the component.

In order to be able to guarantee that the robot program is as up to date as possible, it is advantageous if the system, product and process data are automatically incorporated into the generation of the robot program. For this purpose, for example, a data line, also known as a pipeline, is set up. For example, the electronic computing device or software for determining the operation, in particular according to the first aspect of the invention, is connected to different databases and sources of information in order to be able to retrieve information from it, in particular about the system, especially about changes to the system, and/or about the component, in particular about changes to the component. By applying the so-called single source of truth principle, input data, on the basis of which the operation is determined in an optimized manner, are always up to date. In particular, it is conceivable that a change in the input data, i.e. a change in the product data and/or the system data, in particular in an automated or automatic manner, triggers an in particular new, optimized determination of the operation, so that, for example, for every change in the product data and/or system data, the operation is determined as an optimized operation, in particular in an automated or automatic manner.

With regard to the digital image of the system, in particular including the interference contours, the robot can be positioned and configured in a virtual world by way of a node-based user interface. Using the user interface, for example, a person also known as a user selects the robot, i.e. a model of the robot from a catalog, and imports the selected model into the virtual world, in particular by way of drag-and-drop. Positioning of the robot, especially in the virtual world, takes place, for example, by entering six values. Three of the values are, for example, coordinates, especially relating to a Cartesian coordinate system, wherein a first of the coordinates is, for example, an x-coordinate, a second of the coordinates a y-coordinate and a third of the coordinates a z-coordinate. Three more of the values can describe, for example, a roll, a pitch and a yaw. For example, the configuration of the robot is carried out on the basis of a robot backup. To do this, the user runs the robot backup, also simply known as a backup, and connects it to the robot via the node-based user interface. If the real robot does not (yet) exist, default values are assumed. The interference contours are positioned in a similar way to the robot in the real world. Examples of this are safety fences, conveyor technology and hangers.

In particular, the product data describe a geometric representation of the component or product to be processed, in particular the component or product to be manufactured. The product data can be or include vehicle data, which are created, for example, by designers of a vehicle in a design program such as CATIA. If the system does not yet exist in reality or if the component or product is not yet physically present, the component or product is positioned in an ideal position in the virtual world. If a measurement protocol is available, which characterizes, for example, an actual recording of a real position of a product in the system, the component or product is positioned at a real location in the system in the virtual world. An automated design of the system, in particular robot cell, can be implemented via an interface with a design software of the system. For example, Automation ML or Auto ML can be used for this. With this procedure, the virtual robot model is also equipped with a real robot backup, if this is available.

With regard to the interpretation of the robot task, for example, if a robot program to be optimized already exists, this already existing robot program can be imported into the node-based user interface and linked to the appropriate robot. A specific type of application, such as welding, gluing, sealing, etc., is selected, in particular by the user, to instruct the software on how to interpret the linked robot program. For example, by way of predefined models, also known as templates, value-adding parts (instead of movements between two robot tasks) can be extracted from the robot program. Thus, the processing of these value-adding parts can be optimized in a subsequent step. A premise for this procedure can be that the manual robot programming has been carried out according to the model logic.

In the event that no robot program is yet available, the programming is carried out on the basis of the process data, for example. A basic distinction is made here between two types of applications: point application and path application. In point applications, the robot task takes place at a specific point. An example of this is spot welding, in which a welding spot is produced, i.e. is set, at especially exactly one point. However, it is often the case that the robot moves or has to move a final short distance in or by a linear motion on the way to a point application. The same applies to a first distance after a point application. This leads to the fact that models for point applications can also consist of multiple movement commands, usually three. In path applications, the application takes place while the robot is moving. The template (the model) for path applications can therefore contain at least two movement commands. A PVC application, i.e. the application of a web of a liquid or pasty material, for example to seal the component, which is formed in particular as a seam or forms a seam, is a type of path application, wherein the material can be, for example, a plastic, in particular PVC. It is advantageous if the process data described above contain all the information required to be able to fill in the appropriate models (templates) and thus to be able to carry out suitable robot programming. Values that are not present in the process data can be filled in with a default value. Automation can also be implemented here by storing the robot programs in a database. The software accesses this database and checks whether new robot programs have been added. If this is the case, the optimization is carried out and the optimized program is placed in the database. The same procedure can be used when creating the robot program is carried out on the basis of process data. In this case, the software is connected to the database in which the process data are stored. If the process data change, an update of the robot program can be carried out, in particular in an automatic or automated manner.

When carrying out the optimization of the robot program, i.e. in particular when minimizing the target function on the basis of the data created, i.e. on the basis of the process data, system data and product data, a system for optimization with one or more algorithms is executed, wherein the system, in particular the minimization of the target function, optimizes the robot tasks, i.e. the operation, for example with regard to cycle time, in particular without violating validation criteria. In particular, the target function can be solved or minimized by conventional solution methods or minimization methods, in particular by conventional, commercial and/or, in particular, freely and/or commercially available solvers such as Concorde, GLNS, Greedy, CPLEX Optimization Suite. In the course of optimizing the robot program (operation), the following variables can be adjusted, for example:
Changing the order in which the individual sub-steps (robot tasks) are performed;
Selecting a different tool for performing a sub-step;
Selecting a different linear position for performing a sub-step;
Selecting a different robot configuration for performing the sub-step;
Changing a distribution of sub-steps (robot tasks) to available robots; and
Especially in the case of a path application: adapting or changing a direction along which at least part of the robot travels along a trajectory in order to perform the operation.

It is therefore conceivable that the system has multiple robots, namely the aforementioned robot and at least one other, second robot. Thus, the system data characterizes the multiple robots of the system. Thus, for example, the respective sub-steps of the respective step group may differ from each other in that one of the sub-steps is or can be carried out by the first robot and another of the sub-steps by the second robot. By taking into account the multiple robots available in the system, the operation can be determined particularly advantageously.

It can be seen that a number of the parameters of the target function, also known as variables, can be very large, which can make the underlying optimization problem complex and highly dimensional. Therefore, depending on the structure of the optimization problem, different heuristic solution methods can be suitable for solving the optimization problem and for minimizing the target function in a time-efficient and cost-effective manner for this. There may be different algorithms for solving the optimization problem. For example, a system with a modular architecture can be used, which allows new algorithms to be added efficiently to solve the optimization problem. The resulting ensembles of algorithms can then be started in an automated process in parallel with a given problem instance and run until all algorithms converge or a termination condition, such as a maximum total runtime or desired cycle time, has been reached. Afterwards, the results of the ensemble will be collected and evaluated centrally. For example, the solution with the lowest cycle time is returned and used as the operation.

It is thus possible to automatically start different algorithms with different strengths (for example Greedy, Simulated/Quantum Annealing or GLNS), to supply them with the required data and to evaluate the results afterwards. In other words, for example, different algorithms for solving the same optimization problem can provide different results, i.e. different operations, and, for example, exactly one of the provided operations is selected from these different provided operations, for example depending on a predeterminable or predetermined criterion. The criterion includes, for example, that the operation that fulfils the criterion is selected from the multiple operations that have been determined or calculated. The criterion includes, for example, that the time required by the system to carry out the respective operation, also known as cycle time, is the shortest time, so that, for example, the operation with the shortest cycle time is selected from the multiple operations provided. This simplifies the process of optimization while simultaneously increasing the result quality, as the user only needs to specify a few parameters together with the data set. In addition, the runtime and hardware utilization can be improved. For example, many different robot paths or sub-steps are simulated during the optimization in order to scan the solution space. For successful optimization, it is advantageous that the simulation is carried out with the respective virtual robot controllers of the respective robot manufacturers. Otherwise, the real robot path could deviate from the simulated robot path.

For example, when the optimized robot program, i.e. the determined operation, is output after the distribution of the robot tasks or sub-steps has been determined and the sequence thereof has been optimized, the robot program found is exported, in particular by way of the optimization system. Depending on the user's wishes, the robot programs, for example, can be put into use more or less automatically. There is the possibility of storing the robot program, in particular the determined operation, on a data server, where an operator can access the robot program and carry out subsequent steps manually. Another option is to store the robot program directly on the robot or the controller thereof. This means that fewer manual steps are required to validate the optimized and found robot program, i.e. the determined operation. If the robot programs are also stored in a database, a change history can be evaluated. This makes it possible to evaluate a time profile of the cycle time of the product. On the basis of this, risks in a product development process can be identified at an early stage, for example when the capacity of a robot cell reaches its limit.

Validation of the optimized robot program can include the following: normally, the optimized robot program is run at a low speed with the robot to check or confirm that there is no collision. An application can then be switched on and the robot program is run at normal speed to determine the quality of the robot program. Defects in the robot program can be corrected by hand. An example of this would be a displacement of an application point by a few millimeters. Using the optimized robot program in a production process can include the following: after the robot program has been validated, the robot program can be used in a production process.

In particular, embodiments of the invention enable the realization of at least the following advantages: Due to the automated pipeline of data, the generated robot programs always refer to the latest version of the product and the program is constantly optimized for the cycle time. In general, the advantages can be described as follows:
Savings in costs due to automation by eliminating manual programming steps;
Planning flexibility through early predictability with regard to the possible cycle time;
Assessment competence regarding the capacity of existing robots for new products;
Continuous predictability about the manufacturability of the product;
Holistic optimization of robot lines to increase production volume;
Savings in energy costs through advantageous, especially optimal, use of flexibility in the design of robot paths on different systems;
Saving of additional robot cells through advantageous, especially optimal, use of the existing infrastructure; and
Minimization of sources of error by reducing manual adjustments of the robot program.

In the following, an implementation of the method according to the invention is described using an example of a PVC application. In the PVC application, a web made of a particularly liquid or pasty material is applied to the component. For example, the web is a seam or forms a seam. The material is, for example, a plastic, especially PVC. For example, the component can be sealed against another, additional component by way of the web. In the example, it is assumed that a new production line is being planned and it is questioned whether a planned number of robots is sufficient in terms of production capacity. In order to be able to evaluate the capacity, the previously described method according to an embodiment of the invention is applied. For example, the creation of a virtual production line, i.e. a virtual image of the new production line, is created automatically on the basis of planning software in which the new production line is planned. Thus, correct robot models are positioned on or in or at the correct place in the virtual world, i.e. in the virtual image. The aforementioned node-based user interface allows robot backups of the robots from an existing production line to be linked. The product data of the relevant product, for example in the form of a vehicle, or component are imported directly from a database for product data and displayed in the virtual world (virtual image) at a planned position. For example, only a selection of the relevant product from a drop-down list is used. It should be noted that the product data are always up to date with the latest approved design status because the software always accesses the database directly, for example. Finally, seam information about the seam is read from the database of a PVC design. For example, the relevant seam or seams for the applicable product (vehicle) are automatically selected. This selection takes place on the basis of a knowledge of the relationship between the product data and the process data. After all data have been successfully imported, the actual, real optimization takes place, which is then reflected in the exported robot program, i.e. the optimized, determined operation is output. The advantage of the automated data pipeline is that the robot program is updated without manual effort as soon as a change is made in the system data and/or product data and/or process data. Whether the capacity of the new production line is sufficient to produce the relevant product (vehicle) can be seen from the cycle time or the cycle times of the optimized robot program.

A third aspect of the invention relates to a data-processing device, in particular in the form of an electronic computing device for carrying out the method according to the first aspect of the invention and/or the second aspect of the invention. Advantages and advantageous embodiments of the first aspect and the second aspect of the invention are to be regarded as advantages and advantageous embodiments of the third aspect of the invention and vice versa.

A fourth aspect of the invention relates to a computer program, also known as a computer program product, containing commands which, when executed by a computer, cause the computer to carry out the method in accordance with the first aspect of the invention and/or in accordance with the second aspect of the invention. Advantages and advantageous embodiments of the first aspect, the second aspect, and the third aspect of the invention are to be regarded as advantages and advantageous embodiments of the fourth aspect of the invention and vice versa.

Finally, a fifth aspect of the invention concerns a computer-readable medium on which the computer program in accordance with the fourth aspect of the invention is stored. Advantages and advantageous embodiments of the first aspect, the second aspect, the third aspect, and the fourth aspect of the invention are to be regarded as advantages and advantageous embodiments of the fifth aspect of the invention and vice versa.

Further details of the invention can be found in the following description of a preferred exemplary embodiment with the corresponding drawing.

### BRIEF DESCRIPTION OF THE DRAWING

FIG. 1 shows a flowchart illustrating a method for determining at least one operation to be performed by a robot to process at least one component.

### DETAILED DESCRIPTION OF THE DRAWING

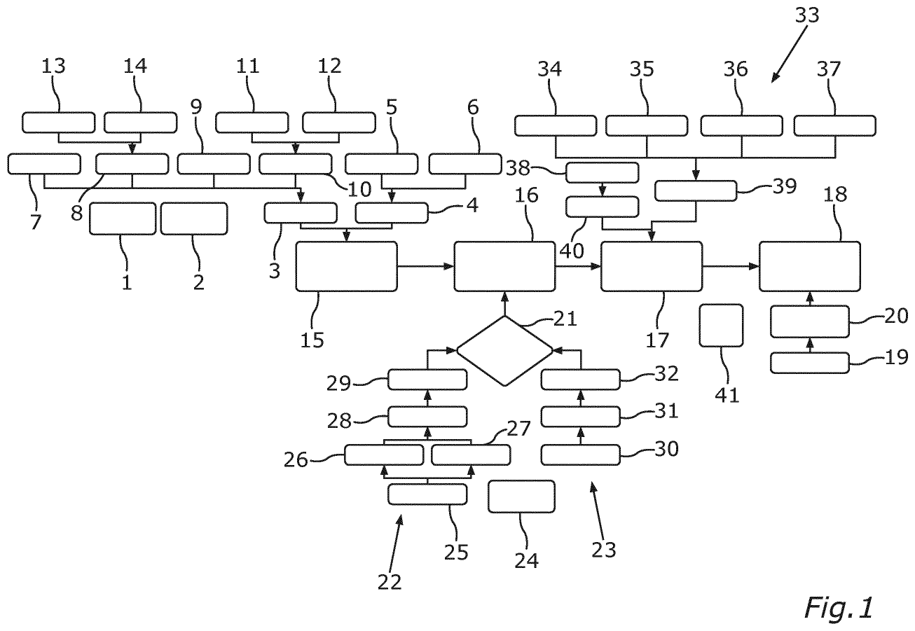

In the following, FIG. 1 is used to explain a method for determining, in particular calculating, at least one operation to be performed by a robot and also referred to as a robot program for processing at least one component. The component is a product or can be a component of a product, wherein the product is produced by the operation, for example. The operation can be composed of multiple sub-steps strung together, i.e. one after the other, so that when the robot carries out the individual sub-steps one after the other, the robot performs the operation as a whole. Expressed again in other words, for example, the temporally consecutive sub-steps, especially in total, form the operation.

In FIG. 1, a block 1 illustrates product data that are determined by way of an electronic computing device by way of which the method is carried out. The product data characterize the at least one component to be processed by the robot in the at least one operation. A block 2 illustrates system data that are determined by way of the electronic computing device and that characterize a system containing at least the robot for performing the at least one operation. The robot is illustrated by a block 3. In other words, block 3, for example, illustrates a first part of the system data, wherein the first part of the system data describe the robot. Block 4 illustrates interference contours. The interference contours illustrated by block 4 can be characterized, for example, by a second part of the product data and/or by a first part of the system data. The interference contours are places at which or to which the robot should not be moved when carrying out the operation, otherwise undesirable collisions could occur. The interference contours can be formed, for example, by the component or product and/or by elements of the system. The elements of the system are, for example, safety fences or other objects. A block 5 illustrates the aforementioned geometry of the component, the geometry of which is characterized, i.e. described for example, by a second part of the product data. For example, a block 6 illustrates a positioning of the component, especially during the performance of the operation. For example, the positioning is characterized, i.e. described, by a third part of the product data. A block 7 illustrates a positioning of the robot, especially during the performance of the operation, wherein the positioning of the robot is described or characterized, for example, by a third part of the system data. A block 8 illustrates a robot backup, which is described, for example, by a fourth part of the system data. A block 9 illustrates a geometry of the robot, the geometry of which is described, for example, by a fifth part of the system data. A block 10 illustrates a kinematic description of the robot, a block 11 illustrates an arrangement of robot axes of the robot, also known as axes, and a block 12 illustrates limit values. It can be seen that the kinematic description (block 10) can result from or that it is related to the positioning of the axes (block 11) and the limit values (block 12). For example, the arrangement of the axes, the limit values and the kinematic description are described by a sixth part of the system data. For example, the robot backup illustrated by block 8 is related to work objects illustrated by block 13 and to tool information illustrated by block 14, wherein, for example, the work objects and the tool information are described by a seventh part of the system data. In particular, the tool information is information about at least one tool of the robot by way of which the tool is moved relative to the component when performing or executing the operation in order to perform the operation, i.e. to process the tool. In other words, for example, the tool information describes the tool mentioned, by way of which, for example, an in particular liquid or pasty material is applied to the component during the operation and/or the component is welded to at least one other component, i.e. at least one welding of the component is carried out.

A block 24 illustrates process data that characterize the operation and that are determined by way of the electronic computing device.

A block 15 illustrates that the electronic computing device is used to create a virtual image of the system and the component, also known as a virtual world. The virtual image is a simulation model or is described by a simulation model, which simulates the system and the component and that is generated, in particular created, by way of the electronic computing device on the basis of the production data and the product data and the system data, which are also referred to as system data.

Block 16 illustrates an interpretation of tasks to be performed in particular by the robot or the system and also referred to as robot tasks.

A block 17 illustrates an optimization or an optimized generation. In particular, block 17 illustrates that a simulation is carried out by way of the electronic computing device using the simulation model. The simulation is used to determine simulation data that describe or characterize multiple step groups, wherein the respective step group contains multiple sub-steps of the operation that are different from each other. From the sub-steps of the step groups determined, in particular calculated, by the simulation the operation or different combinations or variants of the operation could be generated in such a way that exactly one of the respective sub-steps is selected from the respective step group, and that the selected sub-steps are strung together, so that when the robot executes the selected and sequenced sub-steps, the robot performs the operation. The simulation data are illustrated by a block 41.

For example, in the case of block 17 in particular, a target function of an optimization problem is created by way of the electronic computing device, the target function of which contains the sub-steps of the step groups as parameters or variables. By way of the electronic computing device, the target function is minimized during the optimization, whereby in particular exactly one of the respective sub-steps of the respective step group is selected from the respective step group. The selected sub-steps are strung together, whereby the operation, i.e. the optimized operation, is determined. The target function or the solution thereof delivers, for example, such a sequence of the selected sub-steps as a result that the resulting or formed operation can be performed by the system on the one hand and on the other hand has the shortest cycle time in relation to all possible operations that can be formed from the sub-steps of the step groups, which is required by the system to perform the operation.

A block 18 illustrates a return or output of the optimized operation determined in block 17, which is also referred to as an optimized robot program. For example, a block 19 illustrates a translation to a robot language, and a block 20 illustrates a transfer to an OLP software, for example.

In the case of block 16 in particular, the process data can be determined, for example, by way of at least one or more existing robot programs, or, if such an already existing robot program does not yet exist, by other methods. In block 21, for example, it is decided whether at least one robot program is already available. A branch 22 illustrates a procedure that is carried out when a robot program already exists. A branch 23 illustrates a procedure that is carried out when no robot program is yet available. A block 25 of branch 22 illustrates an application technique being switched on and off. Block 26 of branch 22 illustrates a point application, and block 27 of branch 22 illustrates a path application. A block 28 illustrates an import of an or the already existing robot program, and a block 29 of branch 22 illustrates a translation of the imported robot program into a general format. A block 30 of branch 23 illustrates, for example, a design in the form of a vehicle design of the product that is in the form of a vehicle, for example, a block 31 illustrates a database and a block 32 of branch 23 illustrates planning data. A branch 33 that illustrates the optimization (block 17) in more detail includes blocks 34, 35, 36, 37, 38, 39 and 40, which can be further variables of the target function, for example. For example, block 34 illustrates an inverse direction. Block 35 illustrates a selection of the tool. A block 36 illustrates a robot configuration of the robot, and a block 37 illustrates a position of the robot on a linear axis. A block 39 illustrates a method of application, a block 40 illustrates a sequence, especially of the sub-steps, and a block 38 illustrates for example, a distribution of the sub-steps to be carried out to perform the operation among multiple robots of the system, if the system has at least one second robot in addition to the first robot as the aforementioned robot.

### LIST OF REFERENCES

1 Block
2 Block
3 Block
4 Block
5 Block
6 Block
7 Block
8 Block
9 Block
10 Block
11 Block
12 Block
13 Block
14 Block
15 Block
16 Block
17 Block
18 Block
19 Block
20 Block
21 Block
22 Branch
23 Branch
24 Block
25 Block
26 Block
27 Block
28 Block
29 Block
30 Block
31 Block
32 Block
33 Branch
34 Block
35 Block
36 Block
37 Block
38 Block
39 Block
40 Block
41 Block

1-10. (canceled)

11. A method for determining at least one operation to be performed by at least one robot to process at least one component, the method comprising:
determining, by an electronic computing device, product data characterizing the at least one component to be processed by way of the robot in the at least one operation;
determining, by the electronic computing device, system data that characterize a system containing the at least the robot for performing the at least one operation;
determining, by the electronic computing device, process data that characterize the at least one operation;
generating, by the electronic computing device, a simulation model that simulates at least the system and the at least one component based on the product data, the system data and the process data;
carrying out, by the electronic computing device, a simulation by way of the simulation model, whereby simulation data are determined by the electronic computing device that describe multiple step groups, wherein the respective step groups contain multiple sub-steps of the at least one operation that are different from each other;
creating, by the electronic computing device, a target function of an optimization problem, wherein the target function includes the sub-steps of the step groups as parameters; and
minimizing, by the electronic computing device, the target function, whereby one of the respective sub-steps of the respective step group is selected from the respective step group and the selected sub-steps are strung together, and whereby the at least one operation is determined.

12. The method according to claim 11, further comprising:
controlling, by the electronic computing device or by another electronic computing device, the robot such that the robot performs the at least one operation.

13. The method according to claim 11, wherein the product data characterize a geometry of the at least one component and/or an interference geometry to be avoided by the robot.

14. The method according to claim 11, wherein the system data characterize robotic arms of the robot that are connected to each other in an articulated way.

15. The method according to claim 11, wherein the system data characterize at least one tool of the robot that can be moved relative to the at least one component by way of the robot and that is intended for carrying out the at least one operation.

16. The method according to claim 11, wherein the process data characterize at least one of:
at least one trajectory along which at least a part of the robot is to be moved;
at least a speed at which at least the part of the robot is to be moved;
an application distance between a tool of the robot intended to perform the at least one operation and the at least one component;
a grinding parameter, which is a way in which points of a trajectory along which at least part of the robot is moved in order to perform the at least one operation, are traced and/or interpolated;
at least one application parameter characterizing the at least one operation.

17. A method for identifying and testing at least one operation to be performed by system for the processing of at least one component, the method comprising:
storing, in at least one data memory:
design data that characterize multiple products that are different from each other; and
system data that characterize multiple systems that are different from each other for carrying out manufacturing steps;
selecting, by an electronic computing device, depending on inputs into the electronic computing device, a first subset of the design data from the design data, wherein the first subset characterizes one of the products;
selecting, by the electronic computing device, depending on inputs into the electronic computing device, a second subset of the system data is selected from the system data, wherein the second subset characterizes one of the systems;
by automatically determining the electronic computing device, depending on the first subset, at least one operation required for production of the product characterized by the first subset; and
checking, by the electronic computing device, depending on the second subset, whether the system characterized by the second subset is able to perform the at least one operation.

18. A computer product comprising a non-transitory computer readable medium having stored thereon program code which, when executed by a computer, carries out the method according to claim 11.
